(19) United States
(12) Patent Application Publication
(10) Pub. No.: US 2008/0079343 A1
(43) Pub. Date: Apr. 3, 2008

(54) Light fixture

(76) Inventors: Martin Kirsten, Burscheid (DE); Thorsten Kretzer, Leverkusen (DE); Jennifer Gendreizig, Solingen (DE)

Correspondence Address: BERENATO, WHITE & STAVISH, LLC, 6550 ROCK SPRING DRIVE, SUITE 240, BETHESDA, MD, 20817, US

(21) Appl. No.: 11/905,110

(22) Filed: Sep. 27, 2007

(30) Foreign Application Priority Data
Sep. 28, 2006 (EP) 06020375.9

(51) Int. Cl. F21V 13/04; F21V 7/00

(52) U.S. Cl. 313/111; 313/113

(57) ABSTRACT

A light fixture has an illuminant in the form of a high pressure discharge lamp, which is surrounded by a reflector. At least one additional light source radiates single-colored light into the reflector. The additional light source is positioned so that it radiates the single-colored light towards the high pressure discharge lamp. An optical system is provided which focuses the light radiated by the additional light source such that it hits the burner of the high pressure discharge lamp in its entirety.

### CROSS-REFERENCE TO RELATED APPLICATIONS AND CLAIM TO PRIORITY

This application is related to application umber 06 020 375.9, filed Sep. 28, 2006 with the European Patent Office, the disclosure of which is incorporated by reference and to which priority is claimed.

### FIELD OF THE INVENTION

The present invention relates to a light fixture with an illuminant in the form of a high pressure discharge lamp, which is surrounded by a reflector, and with at least one additional light source which radiates single-colored light into the reflector.

### BACKGROUND OF THE INVENTION

In order to light useable surfaces such as goods display surfaces, lighting installations are used in which modern, effective illuminants with a high light output are used, such as for example metal halogen vapor lamps in the light colors warm white (3000 K), natural white (approx. 4000 K) and daylight (approx. 6500 K). The aim always is to evenly illuminate the useable surfaces at low cost and with a high general color reproduction index which reproduces all surface colors as evenly as possible. The aforementioned illuminants emit radiation here in the light spectrum of which all light color portions are present.

When lighting goods display surfaces in sales areas, it is often desirable to increase the color saturation of certain surface colors.

It is known from DE 35 15 879 C1 to use a light fixture with a filter device in order to filter out the corresponding complementary color in the spectral range of 480 to 570 nm so as to highlight a warm tone color such as orange, red or purple. The filtering in this relatively narrow spectral range results in filter transmission curves with steep filter edges. Furthermore, not only is the surface color to be highlighted strengthened, but the light color itself is also greatly changed so that, if applicable, a white surround is undesirably colored red.

The narrow-band filters used are generally produced as interference filters, and their function requires a plurality of interference layers.

Whereas the use of such filters in light fixtures, the lamps of which radiate a continuous light spectrum, such as for example halogen lamps, is relatively unproblematic, the use of this type of filter arrangement proves to be problematic if lamps are used which produce a line spectrum. In particular when using a sodium vapour high pressure discharge lamp with improved color reproduction, with the light spectrum of which red will be highlighted by means of a filter arrangement, the transmission minimum of the filter curve coincides with a steep edge in the light spectrum of this lamp such that tolerances in the filter production, which are unavoidable, have a very strong effect.

A further problem is that the effect of interference filters is dependent to a large extent upon the angle of the light being radiated. This problem is confronted by EP 1 122 488 B1 to the effect that the filter device additionally filters out a part of the color portion of the very surface color which is to be highlighted. The consequence of filtering out this color portion is that the light color is effected such that a white surround is colored less or not at all, i.e. the white background essentially remains white.

By providing filter elements, however, it is necessary to use light sources which have an increased red portion in their spectrum, such as for example incandescent lamps or halogen incandescent lamps.

Furthermore, the illuminant and the filter element must be aligned to one another at a certain angle, due to which flexibility with regard to the structure of a lighting installation fitted in this way is limited.

Furthermore, by using filters light is disadvantageously absorbed. The light which is filtered out is simply lost, due to which the efficiency of the lighting of the lighting installation is reduced.

Furthermore, from DE 200 07 134 U1 a generic lighting installation is known with which, as well as a primary light source, secondary light sources emitting single colors are provided in addition. With this lighting installation, the intensity of the secondary light sources can be infinitely adjusted in order to change the color location, and in particular also the color temperature or light color.

### SUMMARY OF THE INVENTION

It is the objective of this invention to provide a light fixture of the type specified at the start which achieves optimal utilisation of the single-colored radiation emitted by the additional light source.

This objective is fulfilled according to the invention in that the additional light source is positioned so that it radiates the single-colored light towards the high pressure discharge lamp, and in that an optical system is provided which focuses the light radiated by the additional light source so that it hits the burner of the high pressure discharge lamp in its entirety.

With the light fixture according to the invention, in addition to the illuminant lighting the useable surface, which emits a radiation with a high general color reproduction index in the light spectrum of which all light color portions are present, at least one further single-color light source—i.e. emitting in a very narrow spectral range—is provided. By mixing the radiation of the light source emitting a single color with the radiation from the illuminant, the color saturation of the corresponding surface color which is also present within the light spectrum emitted by the illuminant, is strengthened such that this is highlighted. Furthermore, a surface color, which if applicable is not present within the light spectrum of the illuminant, can be mixed with the light spectrum of the illuminant.

It is useful here that the light emitted by the additional light source is aligned and focussed by the optical system so that it hits the burner of the high pressure discharge lamp in its entirety. The burners of high pressure discharge lamps are made of a material such as, for example, aluminium oxide ceramic which strongly disperses the single-colored light hitting it so that it mixes evenly with the light radiated by the high pressure discharge lamp. In this way high color penetration is achieved without the total output of the light fixture being substantially increased by the single-colored light that is added. Moreover, by means of the focussing according to the invention, the single-colored light is prevented from being radiated past the high pressure discharge lamp towards the reflector which would lead to the formation of colored dots on a useable surface to be lit.

According to one embodiment of the invention, provision is made such that the optical system, which can have lenses and/or reflectors, focuses the light onto the center of the burner of the high pressure discharge lamp because in this way very even dispersion is achieved on the burner of the high pressure discharge lamp. Furthermore, several light sources emitting the same color can of course be provided on opposite sides of the high pressure discharge lamp, and in particular be arranged symmetrically so that the burner of the high pressure discharge lamp is irradiated evenly with the single-colored light and consequently even illumination of the reflector is achieved.

If several different surface colors are to be highlighted, it is also possible to provide corresponding light sources emitting single colors from different spectral ranges. If, for example, two surface colors are to be strengthened, it is possible to provide two light sources emitting single colors which respectively emit radiation corresponding to the spectra to be strengthened.

Furthermore, it is also possible to provide a lighting installation with, for example, single-colored light sources emitting in two different spectral ranges, it being possible to switch on one or the other light source alternately according to the spectral range to be highlighted.

Alternatively, or in addition, it is possible to design the single-colored light sources such that they can be dimmed. In this case, by means of the dimmer the brightness on the one hand and also the saturation of the light radiated by the light fixture on the other hand can be adjusted with a particular color.

It is advantageous, in order to achieve particularly homogenous illumination of the useable surfaces and to increase the useable efficiency, to surround the illuminant with a reflector, in particular a reflector producing bat wing light distribution. By means of the reflection of the box reflector, high useable lighting efficiency is achieved, and homogenous diffusion of the radiation emitted by the illuminant is produced. A particularly effective light source emitting a single color, with high efficiency and low maintenance costs, is a light emitting diode (LED).

It is advantageous to provide an illuminant in the form of a metal halogen vapour lamp or a sodium vapour high pressure discharge lamp with improved color reproduction. These types of lamp are modern, effective light sources with a high light output.

### BRIEF DESCRIPTION OF THE DRAWINGS

With regard to further advantages and embodiments of the invention, reference is made to the sub-claims and to the following description of an example of an embodiment, with reference to the attached drawing. The drawing shows as follows:

FIG. 1 is a schematic cross-sectional view of a light fixture according to the present invention.

### DETAILED DESCRIPTION OF THE PREFERRED EMBODIMENT(S)

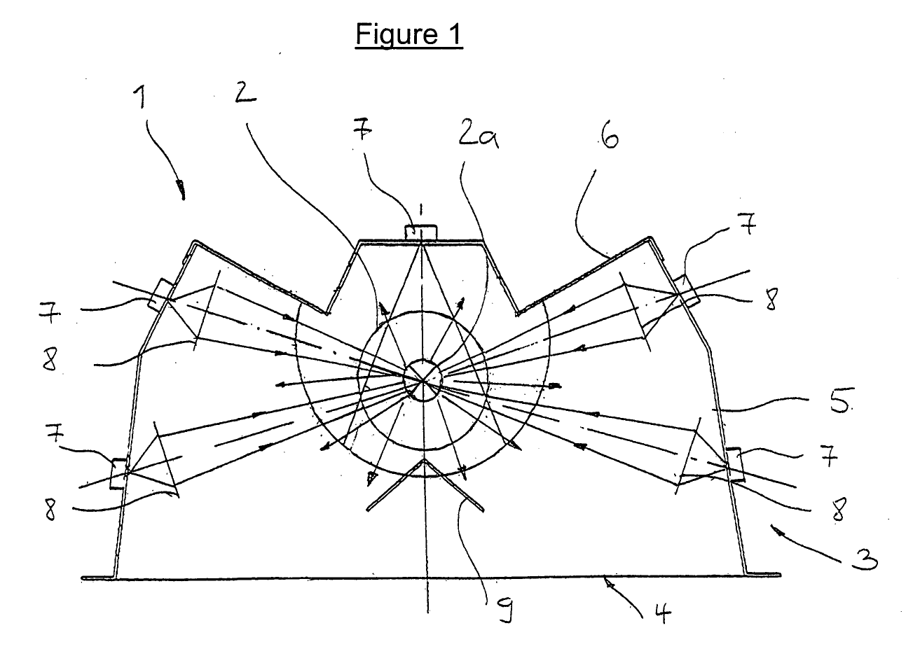

FIG. 1 schematically shows a light fixture 1 according to the invention which can be fitted, for example, to a ceiling. The light fixture 1 has an illuminant 2 which emits radiation with a high general color reproduction index in the light spectrum of which all of the light color portions are present approximately equally. The illuminant 2 here is a high pressure gas discharge lamp with improved color reproduction, such as for example a sodium vapor high pressure discharge lamp or a metal halogen vapor lamp. The illuminant 2 is surrounded by a reflector 3 which produces bat wing light distribution and has a light discharge opening 4 on its lower side. The reflector 3 is of a conventional design and is formed by side reflectors 5 and a cover element 6. This cover element 6 is in the form of a cold light mirror which reduces heat emission.

Disposed on the side reflectors 5 and on the cold light mirror 6 of the reflector 3 are light emitting diodes 7 which radiate into the interior of the reflector 3. According to the invention, a lens 8 is respectively allocated to the light emitting diodes 7 which are disposed on the side reflectors 5, only the optical axis of said lens being shown in the drawing. The lenses 8 are designed and positioned such that they bundle the light radiated by the light emitting diodes 7 and direct it at the high pressure discharge lamp 2 such that all of the single-colored light irradiated by the light emitting diodes 7 hits the burner 2a of the high pressure discharge lamp 2. It can be seen in the drawing that in the present case the lenses 8 focus the light emitted by the light emitting diodes 7 onto the central axis M of the high pressure discharge lamp 2.

With the example of an embodiment shown, a total of four light emitting diodes 7 are disposed on both sides of the high pressure discharge lamp 2 symmetrically to the central plane of the light fixture 1 so that the high pressure discharge lamp 2 is evenly irradiated with the single-colored light. Furthermore, a light emitting diode 7 is provided on the cold light mirror 6 which radiates single-colored light perpendicularly downwards.

The burner 2a of the high pressure discharge lamp 2 is made of an aluminium oxide ceramic, i.e. a material which strongly disperses the single-colored light hitting it from the outside so that it mixes evenly with the light radiated by the high pressure discharge lamp 2. In this way a high level of color penetration is achieved with the result that a homogenous radiation mixture leaves the reflector 3 on the light discharge opening 4 on the lower side, the effect of which is saturation of the desired surface colors on a useable surface to be lit.

Beneath the high pressure discharge lamp 2 a screen 9 is provided which reduces direct radiation of light onto the region of the useable surface to be lit directly beneath the high pressure discharge lamp 2 in order in this way to avoid excessively high light concentrations which can lead to goods being damaged. The screen 9 can have passageway openings (not shown) for the passage of residual light and has on its side facing towards the high pressure discharge lamp 2 a reflective surface which can also be selectively reflective in order to filter out certain color portions.

We claim:

1. A light fixture with an illuminant in the form of a high pressure discharge lamp (2), which is surrounded by a reflector (3), and with at least one additional light source (7) which radiates single-colored light into the reflector (3), characterised in that the additional light source (7) is positioned so that it radiates the single-colored light towards the high pressure discharge lamp (2), and in that an optical system (8) is provided which focuses the light radiated by the additional light source (7) such that it hits the burner (2a) of the high pressure discharge lamp (2) in its entirety.

2. The light fixture (1) according to claim 1, characterised in that on opposite sides of the high pressure discharge lamp (2), and in particular symmetrically to the latter, additional light sources (7) with corresponding optical systems (8) are respectively provided which radiate the same color of light towards the high pressure discharge lamp (2).

3. The light fixture according to claim 1, characterised in that the optical system has at least one lens (8) and/or at least one reflector.

4. The light fixture according to claim 1, characterised in that several light sources (7) emitting a single color with different spectral ranges are provided.

5. The light fixture according to claim 1, characterised in that at least one light source (7) emitting a single color is disposed on the reflector (3).

6. The light fixture according to claim 1, characterised in that the single-colored light sources (7) are light emitting diodes (LED).

7. The light fixture according to claim 1, characterised in that the single-colored light sources (7) can be dimmed.

8. The light fixture according to claim 1, characterised in that the reflector (3) produces bat wing light distribution.

9. The light fixture according to claim 1, characterised in that the illuminant (2) is a metal halogen vapour lamp or a sodium vapour high pressure discharge lamp with improved color reproduction.
